(19) United States
(12) Patent Application Publication
(10) Pub. No.: US 2010/0320887 A1
(43) Pub. Date: Dec. 23, 2010

(54) COVER WHICH MAY BE LOWERED TO CONCEAL THE SUPPORT MECHANISMS OF SLIDING DOORS IN FURNITURE

(76) Inventor: Guido Bortoluzzi, Belluno (IT)

Correspondence Address: KEVIN J. MCNEELY, ESQ., 5335 WISCONSON AVENUE, NW, SUITE 440, WASHINGTON, DC, 20015, US

(21) Appl. No.: 12/446,023

(22) PCT Filed: Oct. 18, 2007
(86) PCT No.: PCT/EP07/09053

§ 371 Date: Apr. 17, 2009

(30) Foreign Application Priority Data
Oct. 18, 2006 (IT) BL2006A000032

(51) Int. Cl. A47B 96/00; H01F 7/00

(52) U.S. Cl. 312/312; 24/303

(57) ABSTRACT

The subject-matter of the invention is a cover which may be lowered to conceal sliding door support mechanisms in furniture, to overlap the upper edge of the cupboard compartment in order to conceal from view the movement and support mechanisms of said sliding doors (20, 30), wherein a cover (50) having a length approximately the same as the width of the useful compartment of cupboard (A), whereby said cover (50) may be placed in a lowered position to allow doors (20, 30) to be applied to tracks (41, 42) of a guide rail (40), and in a raised position, concealing from view the movement and support mechanisms of said doors (20, 30).

This innovation relates to a new type of cover that can be placed between the upper edge of a cupboard compartment and its overlying guide rail, used for the sliding movement of support carriages of the cupboard's sliding doors. The cover has been designed in such a way as to ensure the pleasant aesthetic appearance of the cupboard as it conceals the presence of the guide rail and of its movement mechanisms without significantly affecting the useful height of the cupboard while at the same time permitting inspection of door movement and support mechanisms.

The main characteristic of this innovation is that it provides for the presence and insertion of a cover or profile, which can be applied and lowered along the entire upper length of the cupboard, together with the movement and support guide rail of the sliding door carriages for the movement of the doors, and may be raised, only when said carriages have been definitively positioned and registered on the guide. The cover may be lowered to meet inspection requirements. It is equipped with at least one iron plate, which is aligned to at least one magnet previously positioned in the appropriate part of said guide.

Traditionally, each sliding door of a standard cupboard has lower brackets which slide along guide rails at the bottom of the cupboard and is supported by two support brackets positioned on its upper edge and connected to a similar number of carriages, which are able to move along the tracks or guide rails, the guide rails being soundly positioned along the external surface of the upper horizontal panel or top panel of the cupboard.

It is also a well known fact that the application of guide rails at the top of the cupboard and of brackets at the top of the door, in addition to the insertion of the sliding door carriages, demands that there be sufficient space between the ceiling of the room in which the cupboard is to be placed and the top of the cupboard, thereby reducing the useful height of the cupboard.

For this very reason, the various types of furniture sliding door guides have an external or visible side which is inexistent or as much as possible reduced in height so that the sliding door carriages may be fitted without further impact on the required space, in respect of the ceiling height of the room where the cupboard is to be positioned, and to allow the initial registration and ordinary maintenance over time.

The consequence of this generally adopted method is that sliding door cupboards present an unaesthetic upper gap, through which part of the door movement and support mechanisms are visible, with significant negative visual impact.

The objective of the present innovation is to create a sliding door cupboard, which conceals the unaesthetic view of the carriages and their movement and support carriages, without significant impact on the space required for the application and correct functioning of the door movement and support carriages.

Within the scope of this objective, another important aim of the innovation is to ensure the maximum accessibility and ease of inspection of door guide rails and movement and support carriages.

Another objective of the innovation is that of ensuring maximum stability and manageability of the removable cover to be fitted in order to achieve the desired aesthetic effect.

This and other objectives are in fact successfully achieved through this innovation, which essentially consists in the creation and fitting of a cover or profile, along the entire length of the cupboard compartment, initially in a low position, together with the sliding door movement and support guide rails and before the doors are fitted, to then be raised when said carriages have been definitively registered in their guide rail. This takes place by means of a plate, in iron for example, which is fitted in a specific position on said cover and which is aligned, during the raising of the cover, by at least one magnet which has been previously placed in a specific position on the guide rail.

For a better understanding of the proposed solution and an outline of the achievement of the specified objectives, further details and illustrations are provided hereinafter, based on a construction form which is by no means exhaustive, and supported by four drawings, of which:

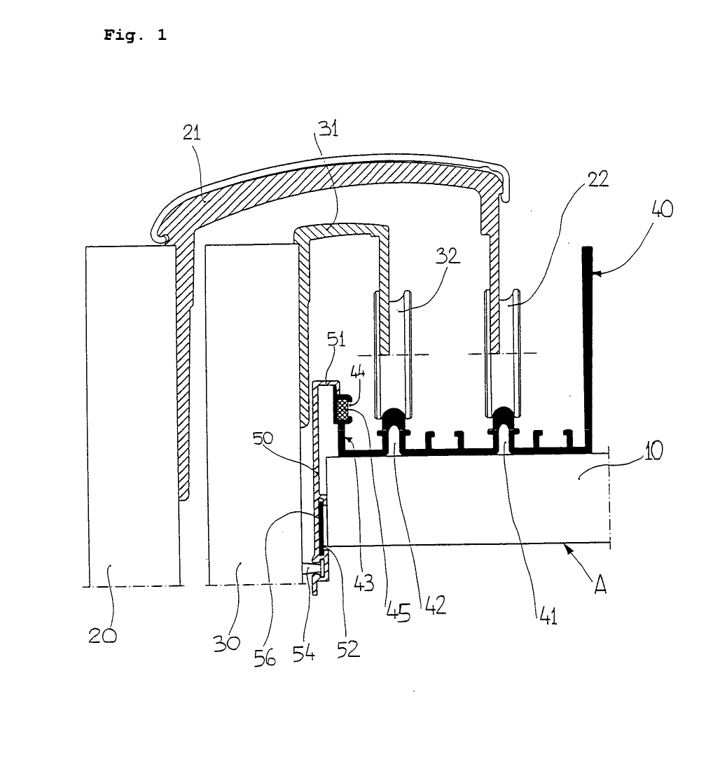

FIG. 1 represents the transversal, partial view of the top of a cupboard of the above type, in which the main movement and support elements of said sliding door cupboard are shown and where an innovative cover is shown in the lowered position;

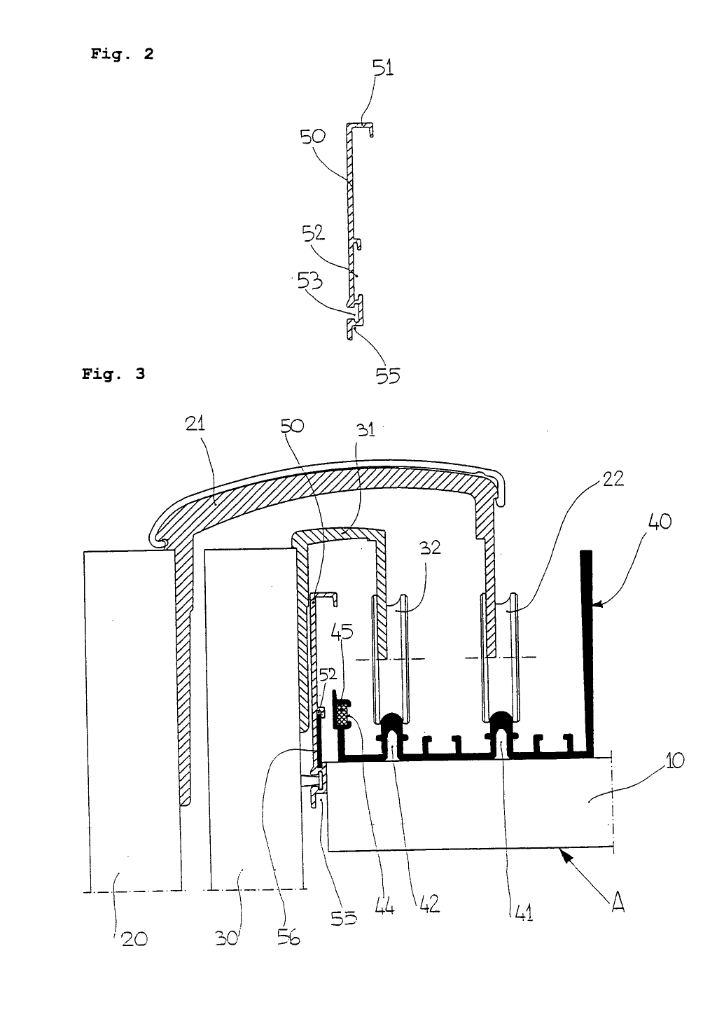

FIG. 2 represents a transversal view of the profile of the cover in FIG. 1;

FIG. 3 represents the transversal view, similar to the view presented in FIG. 1, in which the cover in FIG. 2 is presented in an intermediate, raised position;

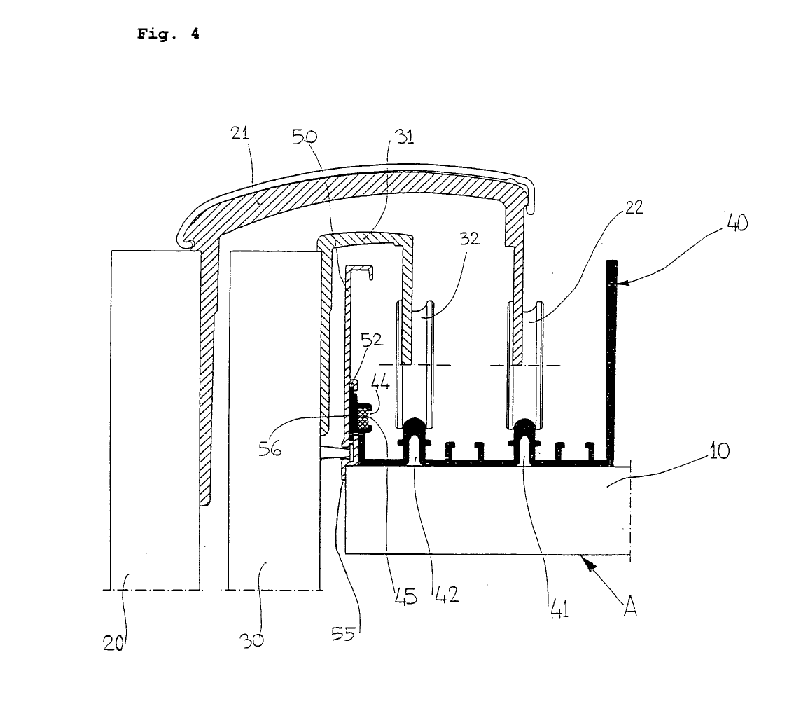

FIG. 4 represents the transversal view, similar to the view presented in FIG. 1 and FIG. 3, in which the cover of FIG. 2 is presented in a raised position;

The same details are presented or are intended as having been presented in all figures with the same reference number.

In accordance with the embodiment shown in the attached figures, part of the top of cupboard A consists of an upper wall or ceiling 10 and of a couple of sliding doors 20 and 30, which are slidingly supported on guide 40 by means of brackets 21 and 31, to which carrying wheels 22 and 32 of respective carriages (not shown) are attached. Said wheels 22 and 32 are attached to the tracks 41 and 42 of said guide rail 40, roughly positioned at the front edge of the top panel 10 of cupboard A.

The front side 43 of said guide rail 40 innovatively presents a longitudinal slot 44 suitable for housing at least one magnetic bar or element 45.

According to FIG. 1, an innovative cover 50 is present, preferably in the form of a section bar, which should at any rate be essentially flat, presenting an upper hook edge 51 and an intermediate section 52 as well as a lower section 53. Section 53 is suitable for housing a flexible brush 54.

The external wall of compartment 53 forms a shoulder 55 with the lower edge of the cover 50.

The intermediate compartment 52 of the cover 50 is destined to house at least one iron bar or element 56, suitably held in place, e.g. by light interference.

Having thus described the few and simple assembly parts illustrated in FIGS. 1-4, a summary of their clear assembly and functionality in relation to achievement of the specified objectives shall now follow.

In reference to FIG. 1 and as previously mentioned, a guide 40 is fixed to the front edge of the top panel 10 of the cupboard A, to which sliding doors 20 and 30 are to be attached, along the entire length of cupboard A, save for the application of closure head panels in accordance to existing methods.

A couple of brackets 21 are generally fixed to the sides of the upper edge of door 20, each of which is of an identical “U” shape, with the opposite side indirectly connected to a wheel 22, which in turn presents a radial slot suitable for housing the track or aisle 41 of guide 40.

In particular, wheel 22 is generally indirectly fixed to the aforementioned bracket 21, in that it is screwed to an adjustment device, not shown as not pertinent, the device or carriage of which is suitable for the vertical positioning of the door 20, to ensure the linearity of its movement on cupboard A.

Similarly, a couple of brackets 31 are fixed to the two sides of the upper edge of the sliding door 30, again shaped in the form of a “U”, but this time of smaller dimension compared to bracket 20, and on the opposite side from the side to which the door 30 is fixed, which is suitable for indirectly supporting one wheel 32, the radial slot of which is capable of housing the aisle or track 42 of the guide rail 40, with similar possibilities of registration of the position of the door 30 compared to its track 42 on cupboard A.

The fixing of the door 30 to the track 42 by means of bracket 31 assumes that the carrying wheel 32 is able to overcome the height of the front side 43 of the guide rail 40, thus said door 30 must be slightly raised so that the wheel 32 can be lowered on track 42.

In the same way the application of door 20 to track 41 assumes that wheel 22 of bracket overcomes the front edge 43 of the guide rail 40, with consequent requirement to raise the door 20 to enable its wheel 22 to be lowered on guide rail 41.

In particular and in accordance with standard methods, the raising of the external bracket 21 and of the door 20 requires a certain availability with respect to the ceiling of the room housing cupboard A, and in fact defines the maximum useful height of cupboard A.

Nevertheless, the presence of the innovative cover 50 does in fact not result in any increase of the required space and ensures that the mobile parts attached to the guide rail 40 are concealed.

The constructive solution which was described also requires a suitable sequence of assembly stages of the doors 20 and 30 to the guide rail 40 above the top section 10 of cupboard A.

In reference to the various figures attached, it is clear that in the first stage of the assembly, guide rail 40 must be soundly fixed to the external surface of top panel 10, in order that its front side 43 is slightly inward facing with respect to the front edge of top panel 10, as well as having at least one magnetic element 45 which is suitably attached to its slot 44.

In the second stage, the top hook 51 of the cover 50 is placed on the upper edge of the front side 43 of the guide rail 40, in order that the cover 50 is supported by the front side 43.

In subsequent stages, the doors 20 and 30 are fixed to tracks 41 and 42 of guide rail 40 by passing their carrying wheel 22 and 32 over the edge 51 of the lowered cover 50, in order that they may be allocated on tracks 41 and 42.

At a later stage, the height and position of sliding doors 20 and 30 is adjusted to ensure their best possible movement on cupboard A, acting on the respective carriages, which are inserted between brackets 21 and 31 and the respective carrying wheels 22 and 32, in accordance with standard methods.

In the final stage, the cover 50 is raised into the intermediate position illustrated in FIG. 3, before reaching its final raised position as illustrated in FIG. 4.

As illustrated in the aforementioned FIG. 4, the attraction of magnet 45 on the iron element 56 ensures that cover 50 reaches its maximum position, blocking the external view of movement and support mechanisms of doors 20 and 30.

In this raised position of cover 50, its shoulder 55 is destined to position itself on the corner between the edge and the upper surface of the top panel 10, and is involved, together with magnet 45 and iron element 56, in the stability of the raised position achieved by cover 50.

For each subsequent registration of the mechanisms for doors 20 and 30 on wheels 22 and 32, it shall of course be sufficient to overcome the force of the magnet 45 in order to shift shoulder 55 and be able to pull cover 50 in a downwards direction until its hooked edge 51 hooks on to the edge of the top side 43 of guide rail 40.

Through this simple cover 50 and its ease of vertical movement, the unaesthetic movement and support parts of doors 20 and 30 are concealed and the cover can be easily adjusted at any time in accordance with some of the specified objectives.

As has already been outlined, the assembly solution, as illustrated and described, may of course be altered to take on other forms of assembly.

For example, we would like to point out the possibility of inverting the position of the magnetic element 45 and of the iron element 56, just as it is possible to envisage the use of two magnets with alternating poles.

On the basis of variation in the assembly procedure, the magnetic components 45 and 56 may be replaced by mechanical components such as, for example, removable fixing screws in the raised position or fixed hook ratchets.

These and other similar modifications or adaptations are to be understood as original parts of this invention.

1. Cover which may be lowered to conceal sliding door support mechanisms in furniture, to overlap the upper edge of the cupboard compartment in order to conceal from view the movement and support mechanisms of said sliding doors, comprising:
a cover having a length approximately the same as the width of the useful compartment of cupboard, whereby said cover may be placed in a lowered position to allow doors to be applied to tracks of a guide rail, and in a raised position, concealing from view the movement and support mechanisms of said doors.

2. over according to claim 1, wherein said cover essentially consists of an essentially flat profile or body with an upper edge in the shape of a hook.

3. Cover according to claim 1 wherein the intermediate section of said cover consists of a longitudinal compartment accommodating and holding at least one iron plate or element to be associated, in the raised position of said cover, with at least one magnet, placed on the guide rail of the sliding doors.

4. Cover according to claim 3, wherein at least one magnet is placed in a suitable longitudinal compartment, created in the top wall of guide rail, said magnet being positioned in such a way that its alignment with the iron element results in magnetic attraction in the closure or fully raised position of said cover on guide rail.

5. Cover according to claim 1, further comprising:
a lower shoulder which is involved in maintaining the raised position of the cover in that it may be positioned on the edge between the upper surface and the front edge of the top panel of cupboard.

6. Cover according to claim 1, wherein the magnet and the iron element may be inverted, between cover and guide rail, and may be replaced by magnetic elements having alternate poles.

7. Cover according to claim 1, wherein the cover in the fully raised position can be fixed to the guide rail by any existing type of mechanical attachment.
